(19) United States
(12) Patent Application Publication
(10) Pub. No.: US 2011/0017848 A1
(43) Pub. Date: Jan. 27, 2011

(54) Sprayer technology

(76) Inventor: Carl A. Keith, Bruce, WI (US)

Correspondence Address: JOEL D. SKINNER, JR.;SKINNER AND ASSOCIATES, 212 COMMERCIAL ST., HUDSON, WI, 54016, US

(21) Appl. No.: 12/804,558

(22) Filed: Jul. 23, 2010

Related U.S. Application Data
(60) Provisional application No. 61/227,981, filed on Jul. 23, 2009.

(51) Int. Cl. B05B 3/00

(52) U.S. Cl. 239/722

(57) ABSTRACT

A sprayer that is particularly useful for golf course turf. The sprayer includes a vehicle, a sprayer connected to the vehicle, and an electric power system for moving the vehicle and for operating the sprayer. The sprayer includes a liquid material storage connected to the vehicle, a spray assembly communicatively connected to the liquid material storage, and a spray boom communicatively connected to the vehicle and to the distribution system for applying a spray to a predetermined location or area proximate the vehicle, The spray assembly includes a pumping system communicatively connected to the electric power system and to the liquid material storage. The spray assembly also has a filtering system communicatively connected to the liquid material storage the spray assembly also has a distribution system communicatively connected to the liquid material storage for controlling and selectively moving liquid material in at least a pair of direction. The electric power system includes at least one battery, at least one electric motor connected to the battery, to the vehicle for moving the vehicle, and to at least one pump for supplying liquid material to the sprayer.

### CROSS-REFERENCE TO RELATED APPLICATIONS, IF ANY

This application claims the benefit under 35 U.S.C. §119(e) of co-pending U.S. Provisional Patent Application Ser. No. 61/227,981, filed Jul. 23, 2009, which is hereby incorporated by reference.

### 37 C.F.R. §1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to golf course maintenance, sports turf, parks and recreation, and professional turf care systems, apparatus and methods. Particularly, the invention relates to a sprayer therefor.

2. Background Information

Greens sprayers are typically used to spray golf course turf (tees, fairways, rough and/or greens) with liquid chemicals such as fertilizers, herbicides, insecticides, and other pesticides.

Known sprayers are believed to present problems with noise and pollution. No known sprayer utilizes battery power both for transportation and for delivering material.

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides a turf sprayer apparatus and method which are practical, reliable, accurate and efficient, and which is believed to fulfill the need and to constitute an improvement over the background technology.

In one aspect, the invention provides a sprayer comprising a vehicle, a sprayer connected to the vehicle, and an electric power system for moving the vehicle and for operating the sprayer.

In another aspect, the invention provides a fully electric sprayer for use in golf course maintenance, comprising

a. a vehicle;
b. a sprayer connected to the vehicle, and including

(1) a liquid material storage connected to the vehicle,

(2) a spray assembly communicatively connected to the liquid material storage, the spray assembly including
(i) a pumping system communicatively connected to the electric power system and to the liquid material storage;
(ii) a filtering system communicatively connected to the liquid material storage; and
(ii) a distribution system communicatively connected to the liquid material storage for controlling and selectively moving liquid material in at least a pair of directions;
and

(3) a spray boom communicatively connected to the vehicle and to the distribution system for applying a spray to a predetermined location or area proximate the vehicle; and

c. an electric power system for moving the vehicle and for operating the sprayer, the electric power system including at least one battery, at least one electric motor connected to the battery, to the vehicle for moving the vehicle, and to at least one pump for supplying liquid material to the sprayer.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of an embodiment of the sprayer of the invention.

FIG. 2A is a side elevation view of the sprayer.

FIG. 2B is an opposite side view of the sprayer.

FIG. 3 is a front, end view of the sprayer.

FIG. 4 is a top, plan view of the sprayer.

FIG. 5 is a perspective view of an embodiment of the nose cone and operator seating area of the sprayer.

FIG. 6 is a perspective view, partially exploded, of an embodiment of the seat console and Role Over Protection Structure (ROPS) of the sprayer.

FIG. 7 is an exploded view of an embodiment of the spray material filtration system of the sprayer.

FIG. 8 is an exploded view of an embodiment of the spray material distribution manifold of the sprayer.

FIG. 9 is an exploded view of an embodiment of the spray material pumping system of the sprayer.

FIG. 10 is an exploded view of an embodiment of the front axle assembly of the sprayer.

FIG. 11 is an exploded view of an embodiment of the rear axle, motor drive, and brake systems of the sprayer.

FIG. 12 is an exploded view of an embodiment of the tank assembly of the sprayer.

FIG. 13 is an exploded view of an embodiment of the spray material agitator of the sprayer.

FIGS. 14A, B and C are schematic diagrams of an embodiment of the electrical system of the sprayer.

FIG. 14D illustrates an embodiment of the console of the sprayer.

FIG. 15 is an exploded view of an embodiment of a manifold ball valve of the sprayer.

FIG. 16 is an exploded view of an embodiment of the motorized control valve of the manifold system of the sprayer.

FIG. 17 is an exploded view of an embodiment of a strainer of the filtration system of the sprayer.

FIG. 18 is an exploded view of an embodiment of a manual boom of the sprayer.

FIG. 19 is an exploded view of an embodiment of the nozzle assembly of the manual boom shown in FIG. 18.

FIG. 20 is an exploded view of an alternative embodiment of the boom of the sprayer.

FIG. 21 is a detailed exploded view of an embodiment of the boom hinge shown in FIG. 20.

FIG. 22 is an exploded view of an embodiment of a water fill meter of the sprayer.

FIG. 23 is an exploded view of an embodiment of a hose reel assembly of the sprayer.

FIG. 24 is an exploded view of an embodiment of a hose reel mount of the sprayer.

FIG. 25 is an exploded view of an alternative embodiment of a hose reel mount.

FIG. 26 is an exploded view of an embodiment of a triple nozzle assembly for use with the boom shown in FIG. 21.

FIG. 27 is an exploded view of an embodiment of a hose reel plumbing assembly of the sprayer.

FIG. 28 is an exploded view of an embodiment of a fresh water wash tank assembly of the sprayer.

FIG. 29 is an exploded view of an embodiment of a chemical cleanload assembly of the sprayer.

FIG. 30 is an exploded view of an embodiment of a mount for the freshwater wash tank assembly of the sprayer.

### DETAILED DESCRIPTION

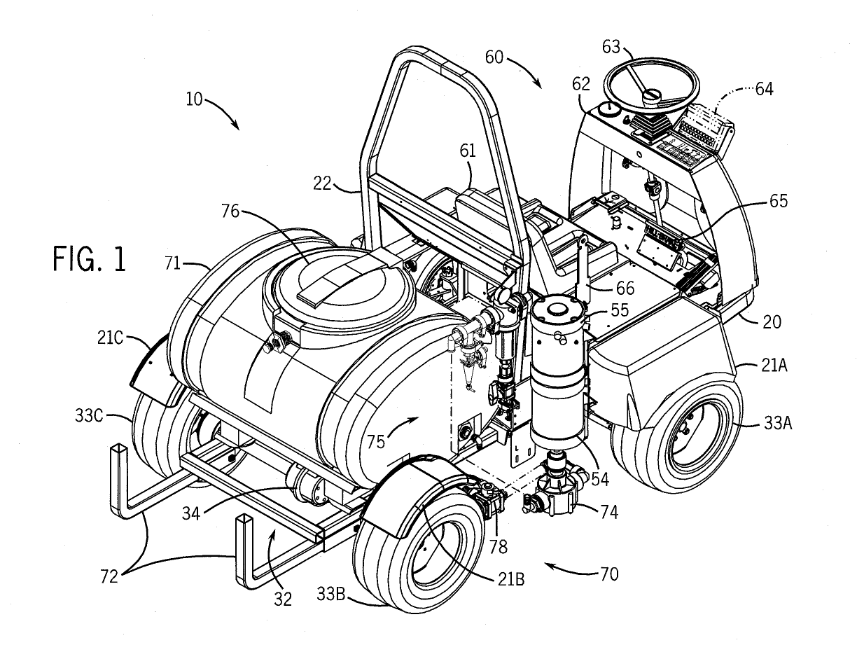

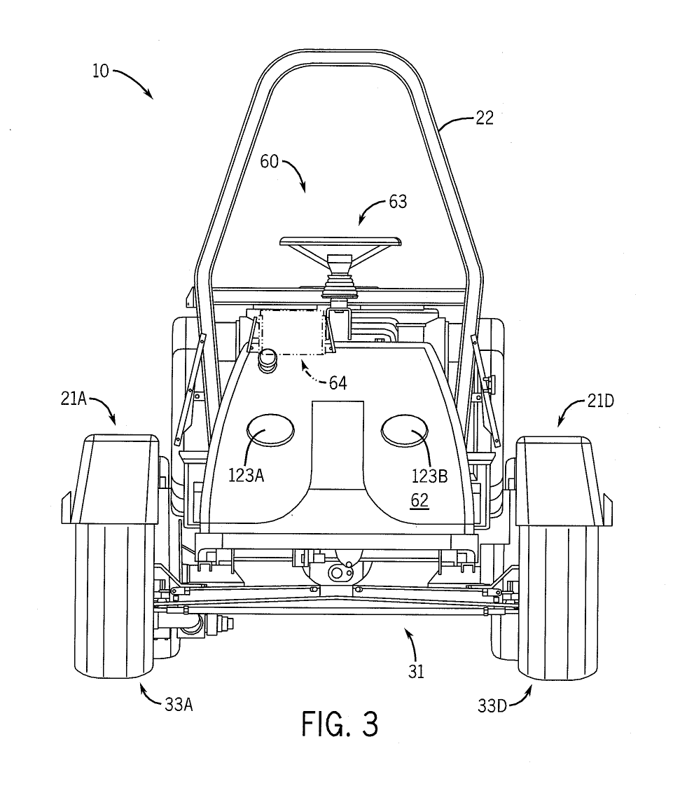

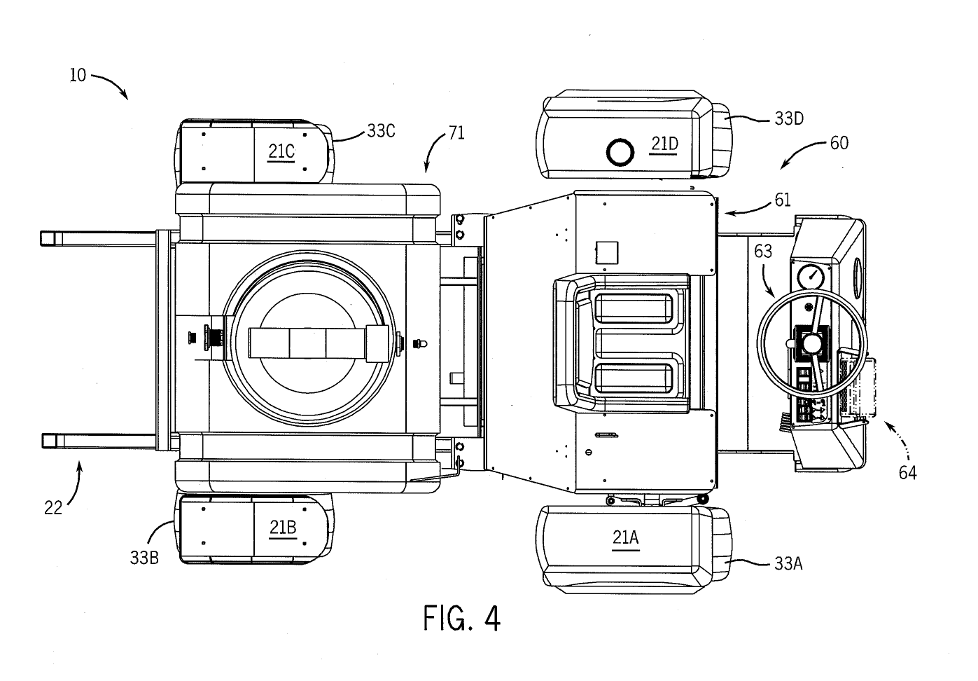

FIGS. 1-4, show an embodiment of the sprayer 10 of the present invention. In general, the remaining drawing figures show embodiments of the parts and assemblies thereof, and the preferred interconnection thereof. The sprayer 10 is a rider or vehicle type system which, in general comprises a rigid frame 20, a lightweight but durable body, an electrical control system 50, a drive system 30 and a spray system 70. Significantly, the sprayer 10 uses battery power for locomotion, and for material delivery, i.e. spraying. The sprayer of the preferred embodiment has dimensions 112 inch long, 70 inch wide, 48 inch high with a weight 1700 lbs (empty) and 2580 lbs (full). The sprayer 10 preferably has a forward speed range of 0-9 mph and reverse speed from 0-4 mph

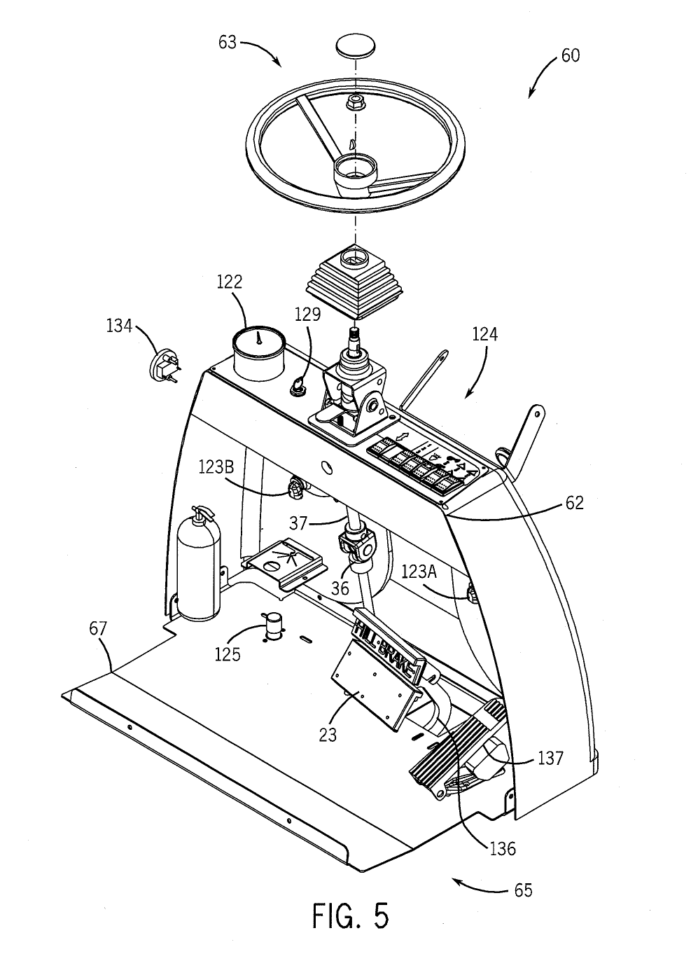

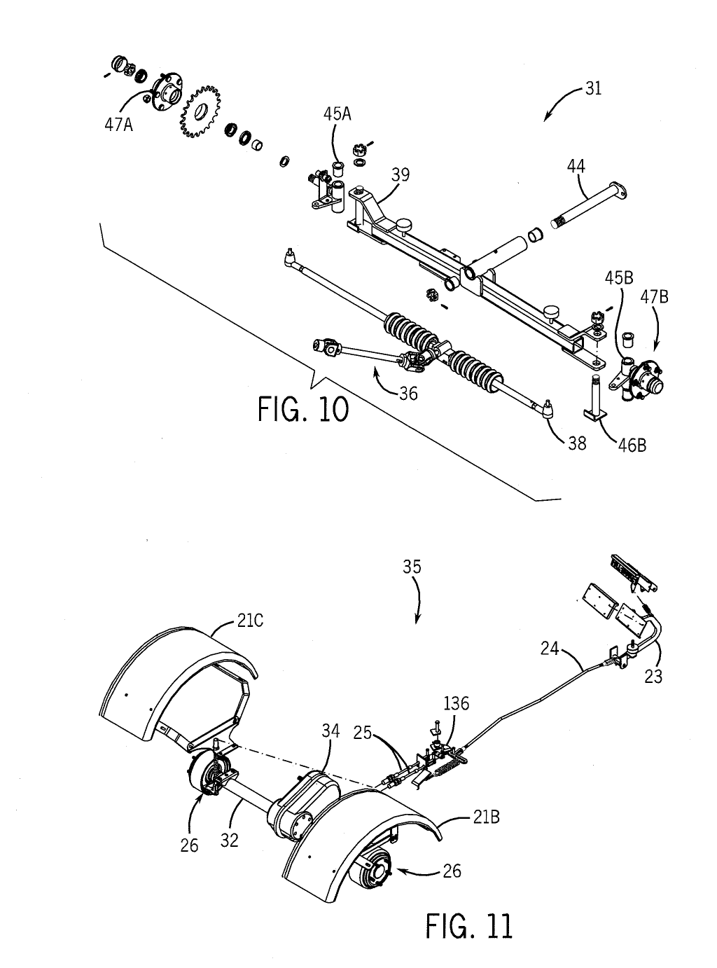

Referring also to FIGS. 10 and 11, the sprayer 10 has a base frame 20, a front axle and steering system 31, a rear axle assembly 32, a drive motor 34 and brake system 35. Wheel/tire assemblies 33 are attached to the axle assemblies 31 and 32. Fenders 21 are attached to the frame proximate the wheel/tire assemblies 33. The steering system 31 is preferably a rack and pinion system including a lower steering kit 36 (attachable to upper steering kit 37 of cab (best shown in FIG. 5), steering rack 38, axle 39, axle pin 44, left and right spindles 45 a and b, king pins 46 a and b, and left and right hubs 47 a and b. The brake system includes brake pedal 23, brake cable 24, brake switch 136, rear cables 25 a and b, and brake assemblies 26.

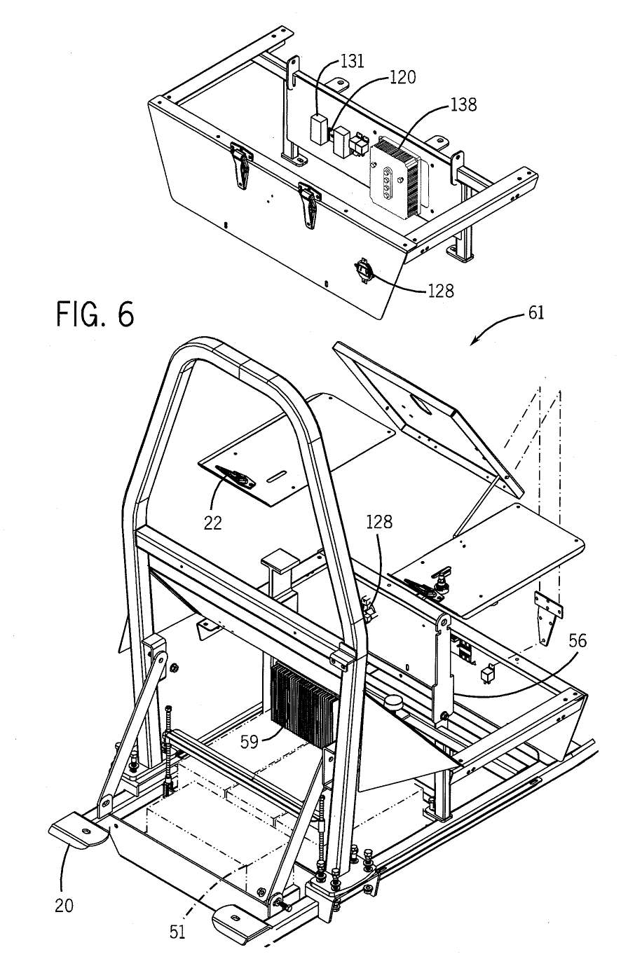

Referring also to FIGS. 5 and 6, an operator cab arrangement 60 is disposed generally on the forward end of the frame 20. The operator cab arrangement 60 preferably comprises a seat assembly 61 and a nose cone assembly 62. A Roll Over Protection System (ROPS) preferably includes a roll bar 22.

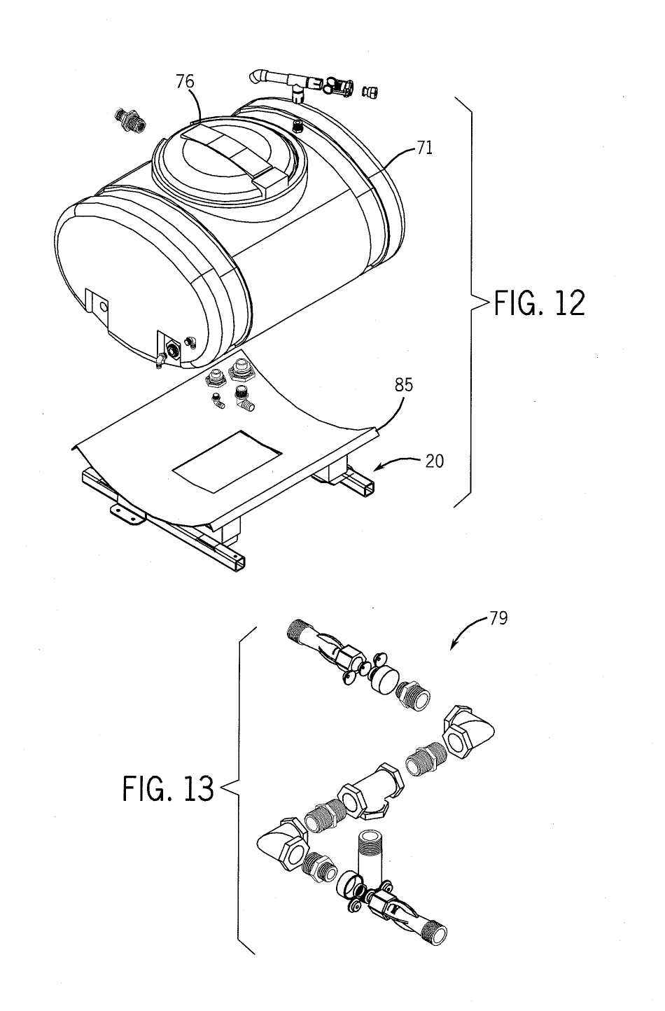

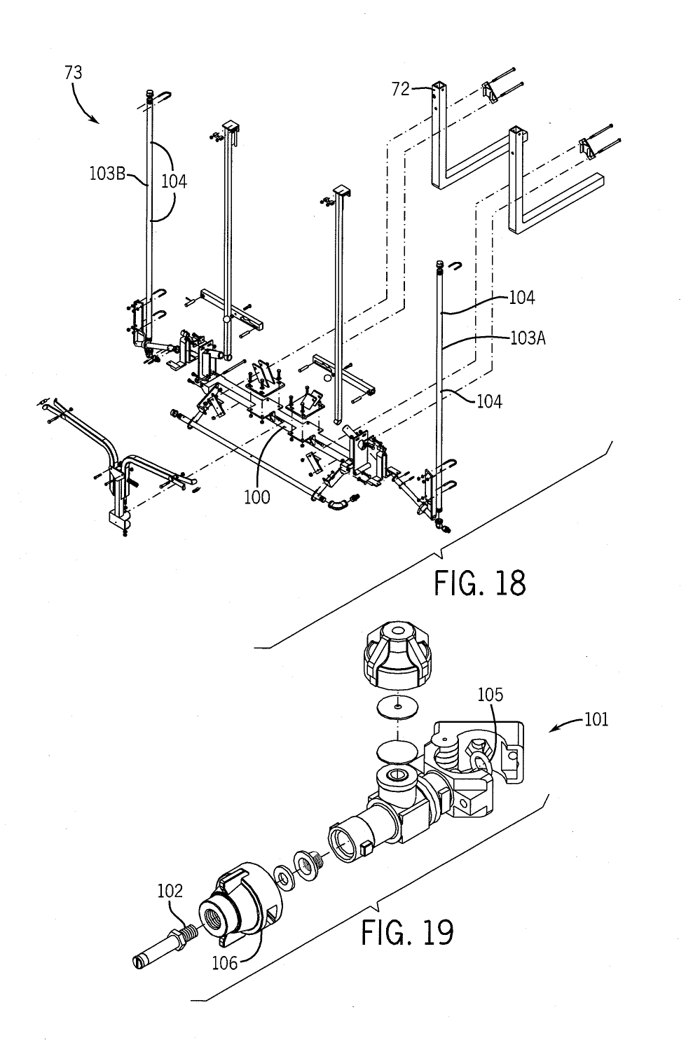

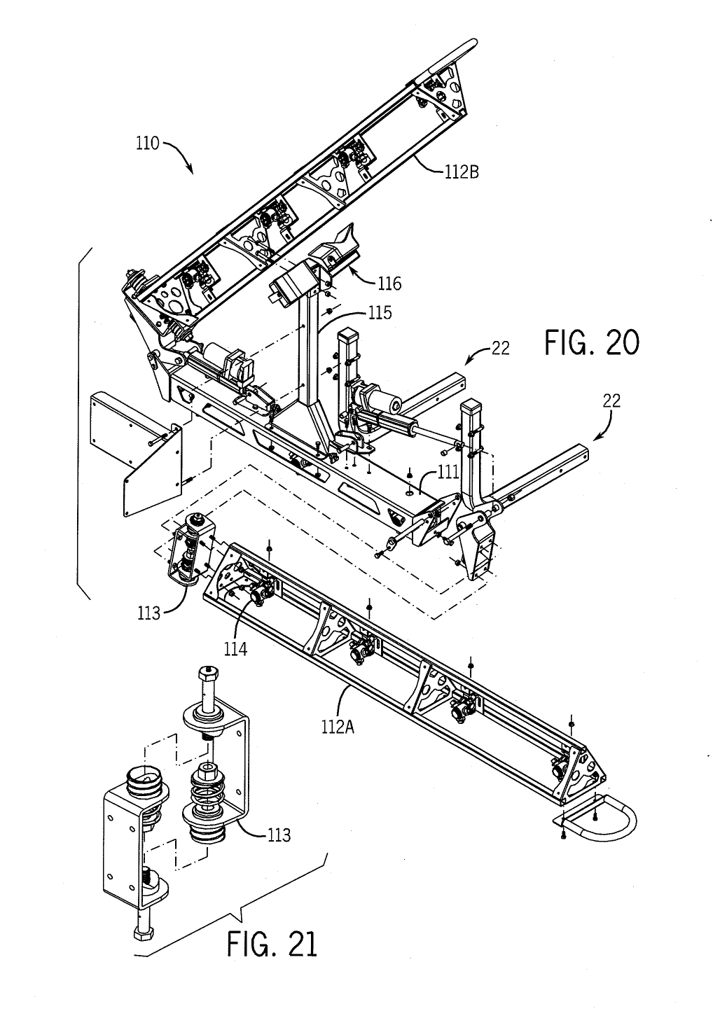

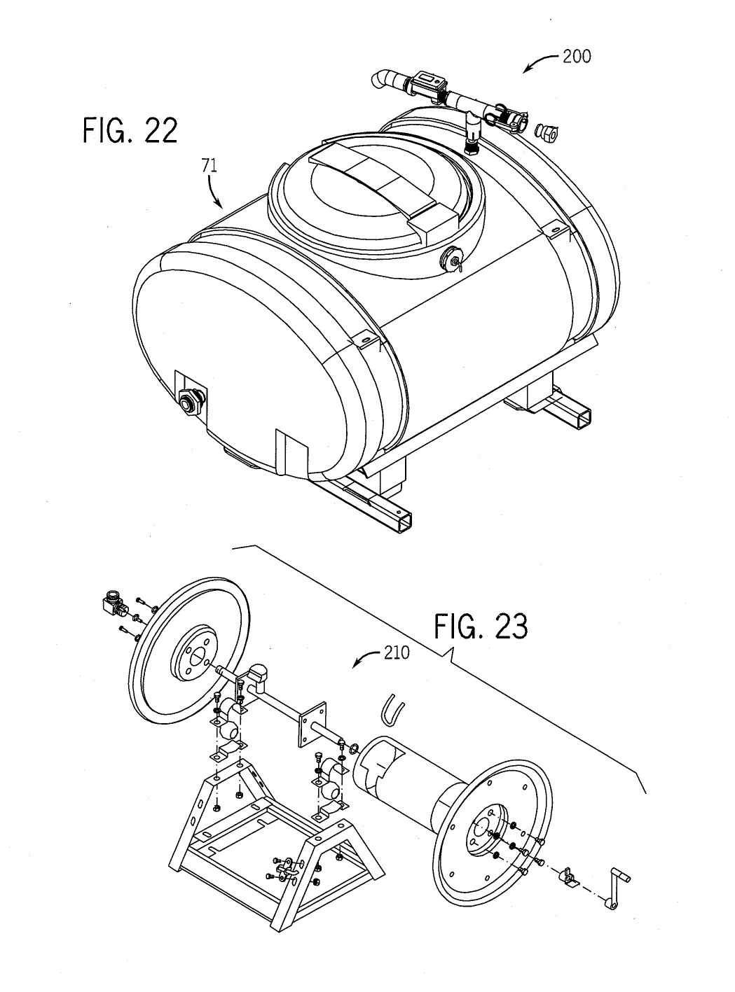

Referring to FIGS. 1, 2, 4 and 12, a spray system 70 is disposed generally on the rearward end of the frame 20, behind the operator cab arrangement 60. The spray assembly preferably comprises a tank 71, an agitator 79 (an embodiment of which is shown in FIG. 13) disposed within the tank 71, a pumping assembly, a filter system 75 and a manifold distribution system 77. Spray boom systems shown in FIGS. 18 and 20 are attachable to the back end of the sprayer 10 for connection to the other elements of the spray system 70 for delivering spray materials such as fertilizer, pesticides and herbicides to ground, particularly turf, and most particularly golf course grounds and turf. Material stored in the tank 71 is pumped through the filtration system 75, and distributed by the manifold system 77 to the boom. These systems are controlled by the operator via the electronic control system, generally represented at 50. As is best shown in FIG. 12, the tank 71 is preferably a 110 gallon elliptical polyethylene tank connected to the frame 20 via carrier 85.

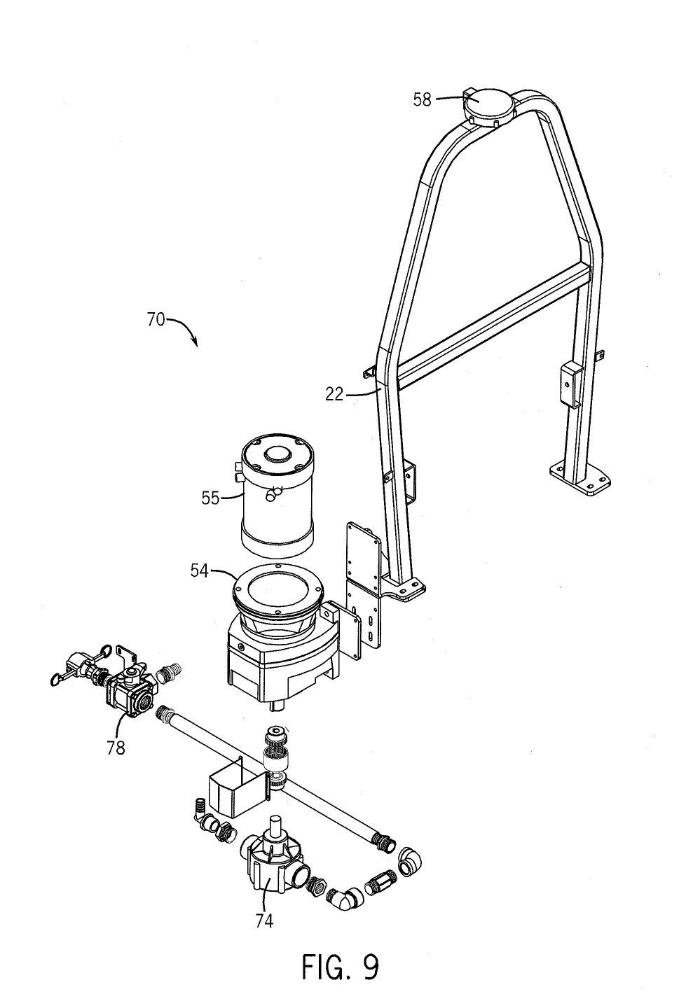

Referring to FIGS. 1, 2A, and 9, pump system 70 preferably comprises a motor 55 (preferably 48V) connected to a cone drive gear box 54, which is connected to pump 74 (preferably a roller pump), which is connected to a 3 way valve 78.

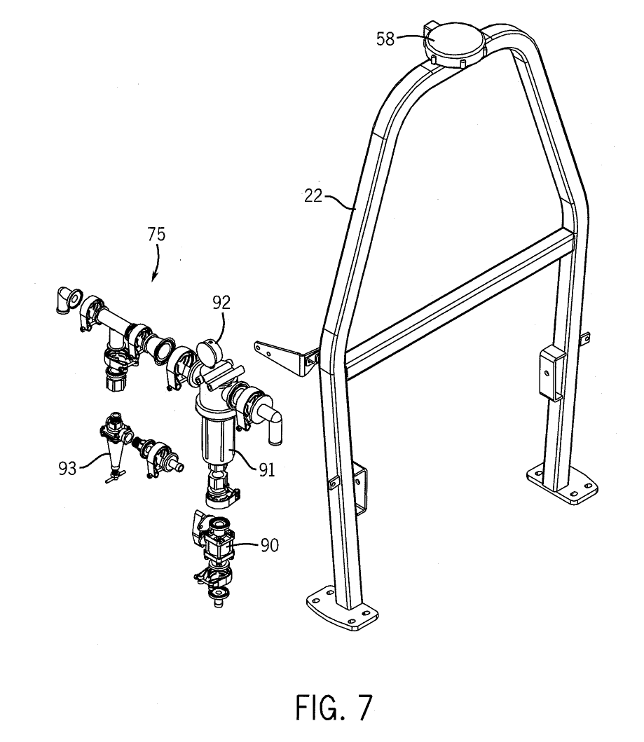

Referring to FIGS. 1, 2A and 7, the filtration system 75 preferably comprises a ball valve 90 connected to strainer 91 which is communicatively connected to pressure gauge 92, and which is connected to pressure relief valve 93. An embodiment of the strainer 91 is further shown in FIG. 17 including a strainer head 94, mesh strainer 95 and bowel 96.

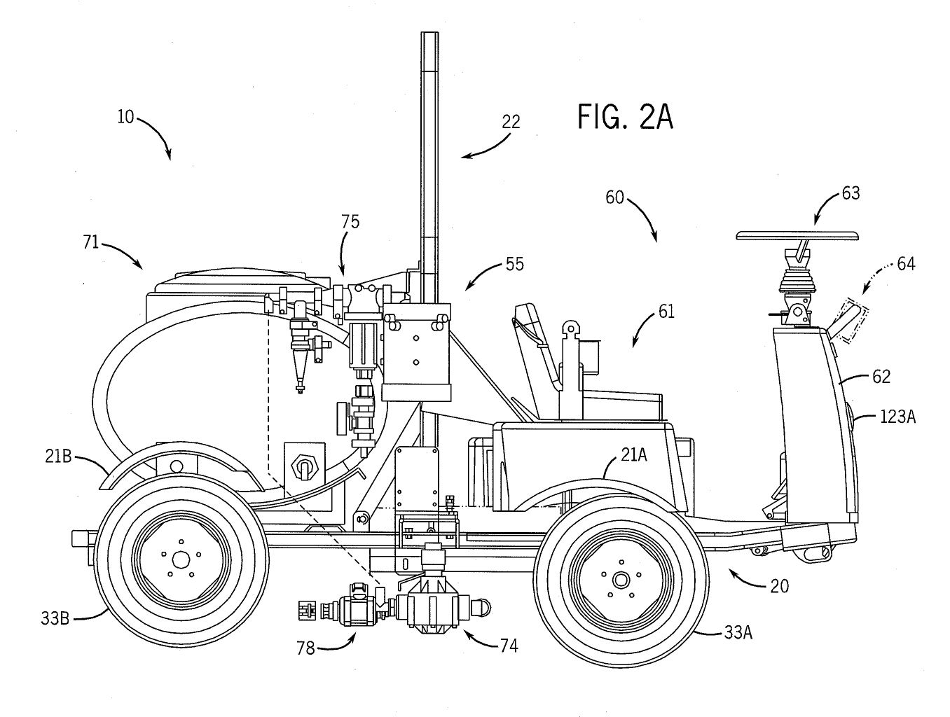

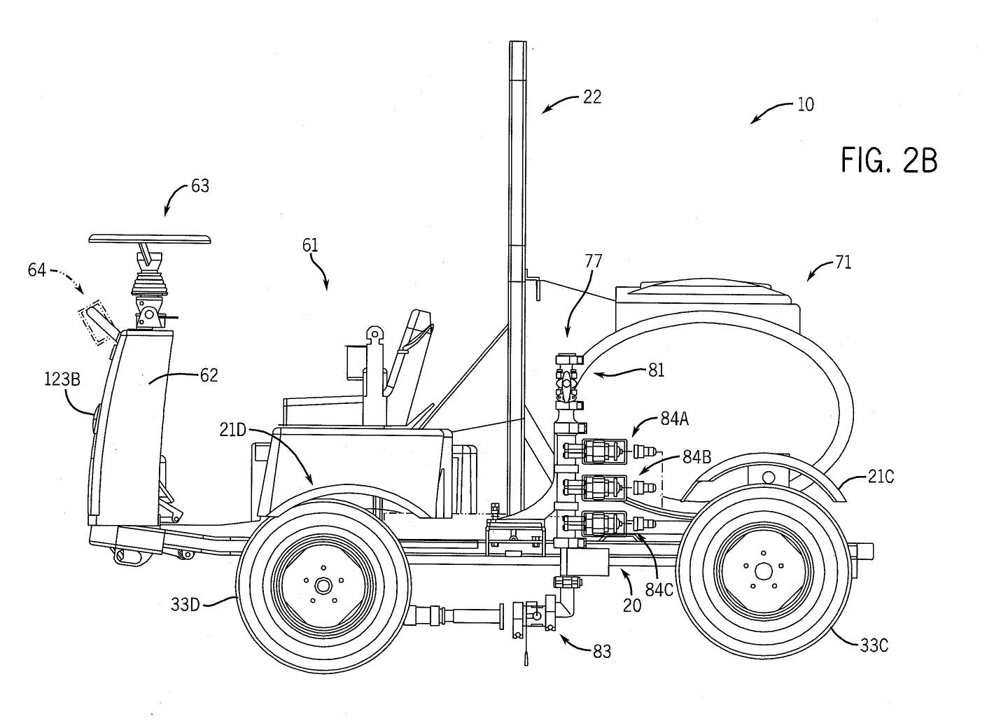

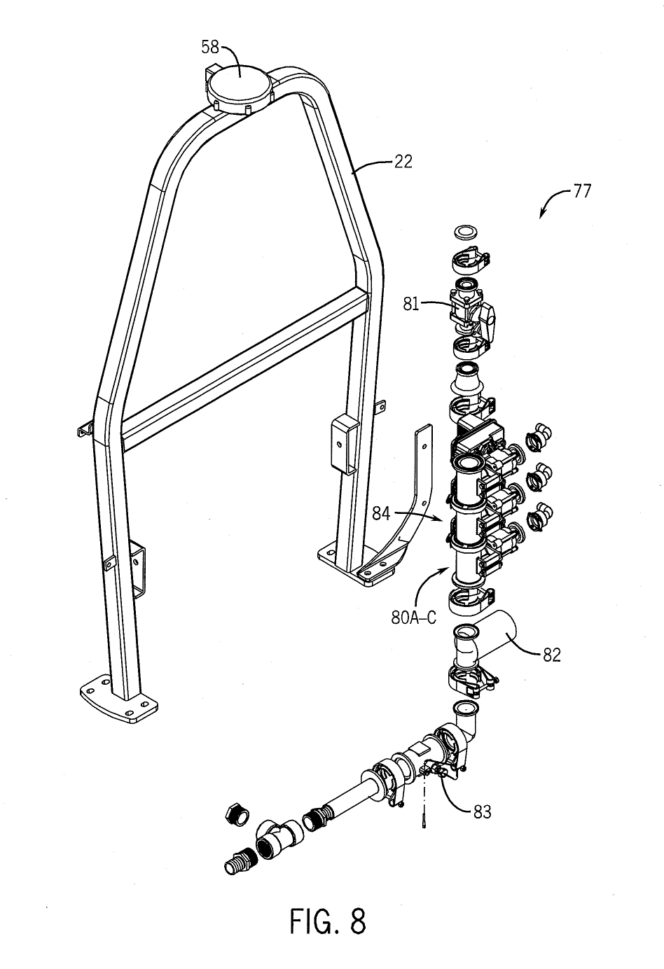

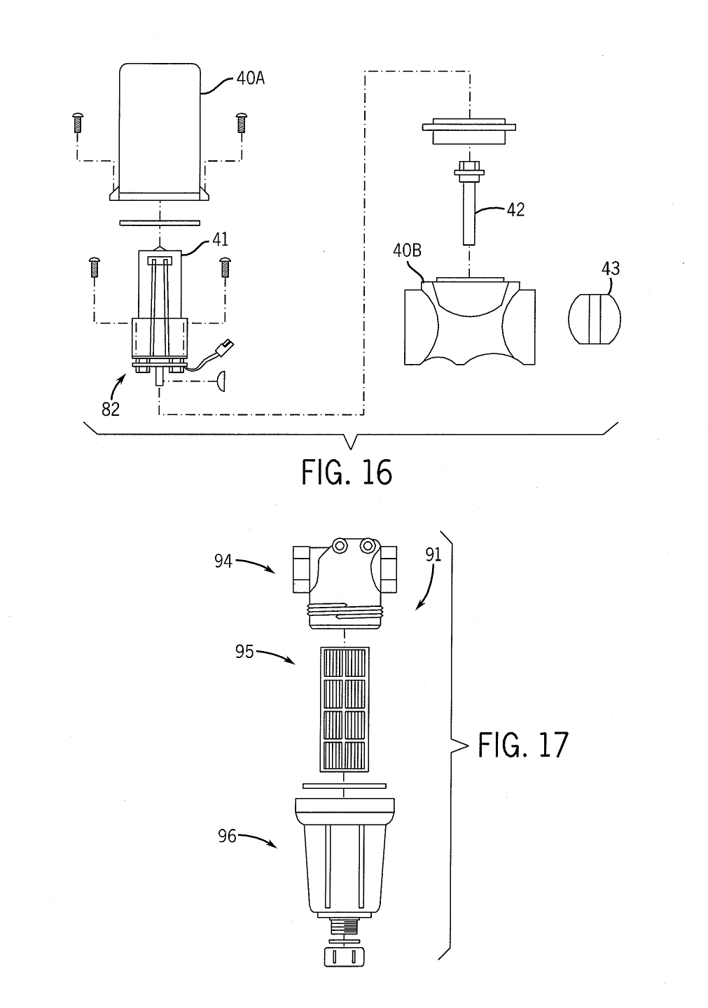

Referring to FIGS. 2B and 8, the boom distribution system 77 preferably comprises a ball valve 81 connected to a series of manifold control valves (preferably ball valves) 80 A, B and C, a motorized control valve 82, and a flow meter 83. These elements are supported by a mount 84 connected to the ROPS 22. An embodiment of the manifold control valve 80 is further shown in FIG. 15 including a motor 86, body 87, and T-body 88. An embodiment of the motorized control valve 82 is further shown in FIG. 16 including cover and body 40A and B, motor 41, shaft 42 and butterfly 43.

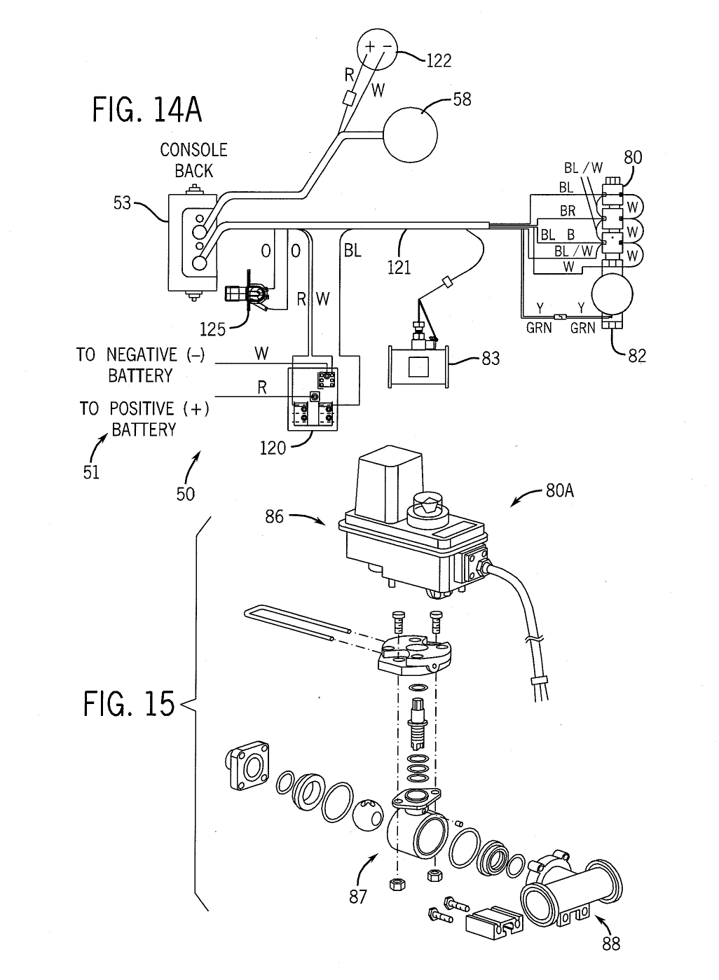

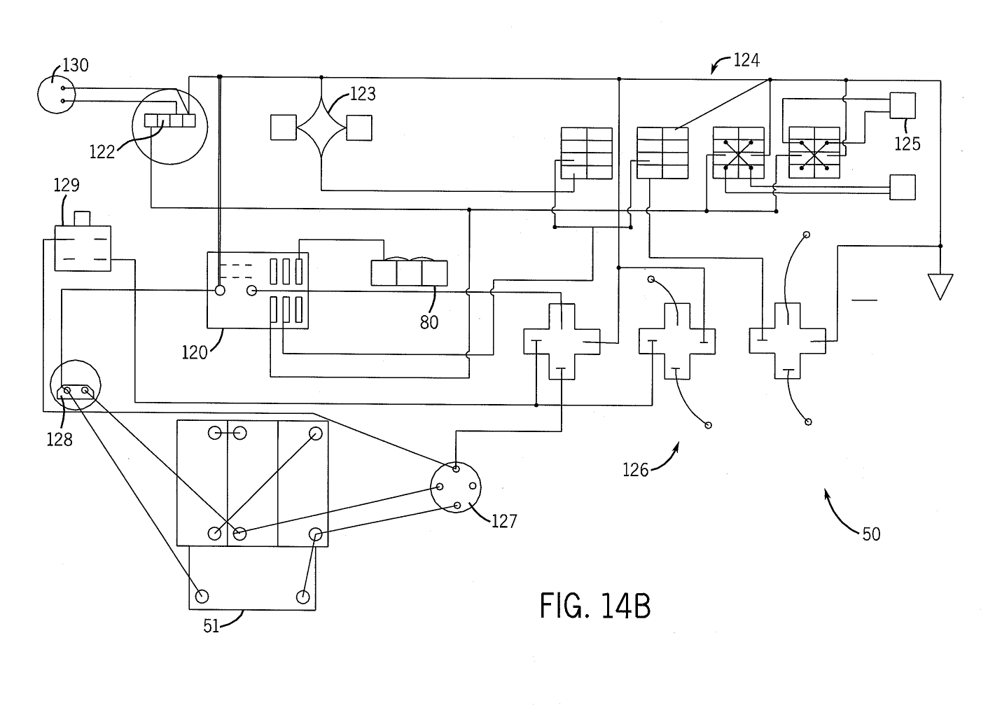

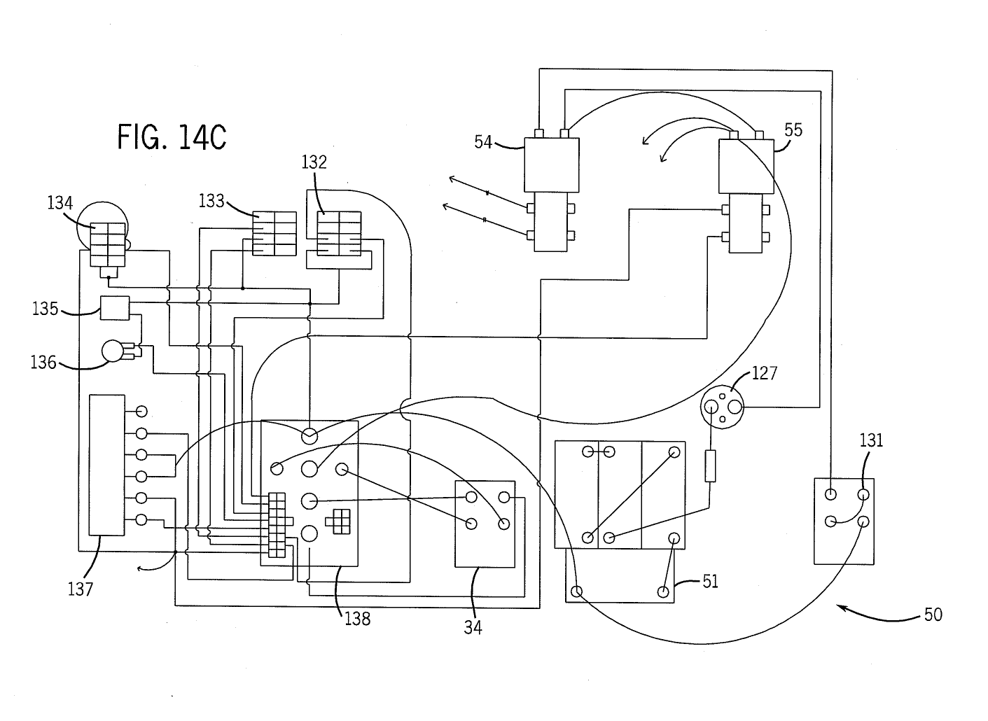

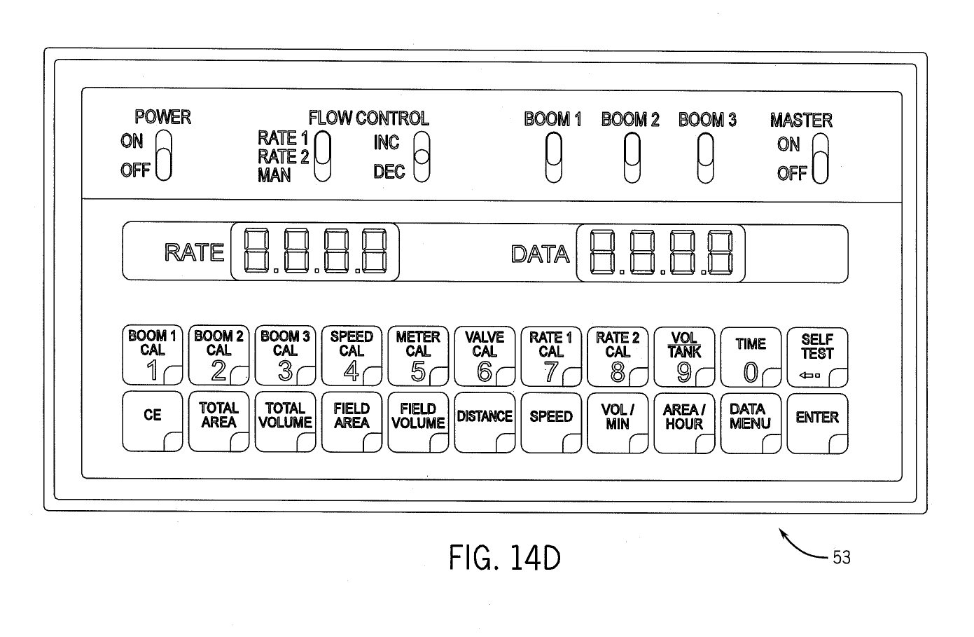

The electrical system 50 preferably is a dual voltage system. Referring to FIG. 14A, the system 50 includes a battery array 51 (preferably 4 12 volt DC batteries) connected to a fuse block 120 connected to control console 53 (via cable 121, boom actuator 125, speedometer 122, GPS system 58, flow meter 83, manifold valves 80, and control valve 82. A preferred embodiment of the console is shown in FIG. 14D. Referring to FIG. 14B, 12-Volt wiring harness includes the battery array 51, charge receptacle 128, the fuse block 120, master disconnect 127, ignition, drive and spray pump relays 126, R-Boom, L-Boom, Pump and Light switches 124, lights 123, the ball valve 80, speedometer 122, magnetic or optical wheel sensor 130, and ignition switch 129. Referring to FIG. 14C, 48-Volt wiring harness includes the battery array 51, the master disconnect 127, contactor 131, the 48V motor 55, the cone drive gear 54, 1^{st}, 2^{nd} and 3rd gear switches 132, forward and reverse switches 133, seat switch 135, brake switch 136, foot pedal 137, controller 138 and contactor 34.

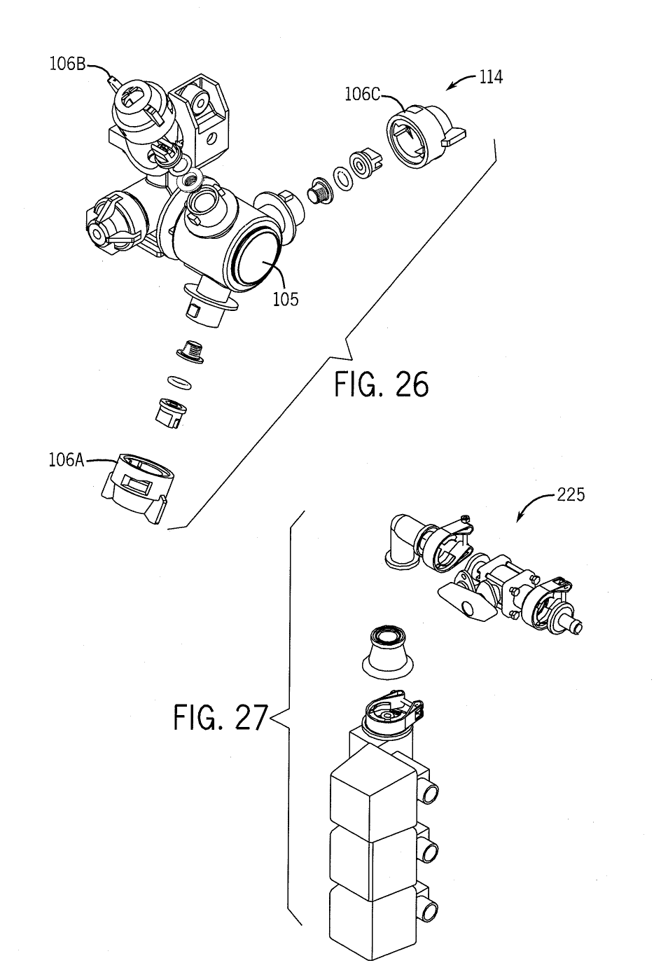

Returning to FIG. 18, manual boom 73 is communicatively connected to the distribution manifold system 77 and receives liquid for spraying to ground. The boom 73 includes a center mount 100 (connected to boom carrier 72 connected to frame 20) pivotally connected to a pair of retractable and spreadable booms 103 a and b. Booms 103 are hollow tubes through which liquid material flows and have spaced apertures 104. Nozzle assemblies 101 (shown in FIG. 19) or 114 (FIG. 26) are connected at apertures 104 to receive material and create a spray. Nozzle assembly 101 includes body 105, cap 106 and jet tip 102. Nozzle assembly 114 includes body 105 and spray caps 106a, b and c. Nozzle assembly 101 may also be used with alternative boom 110. Referring to FIG. 20, boom 110 includes center mount 111 (connected to boom carrier 71), boom arms 112 a and b, boom hinges 113 (best shown in FIG. 21), nest post 115 and nest plates 116.

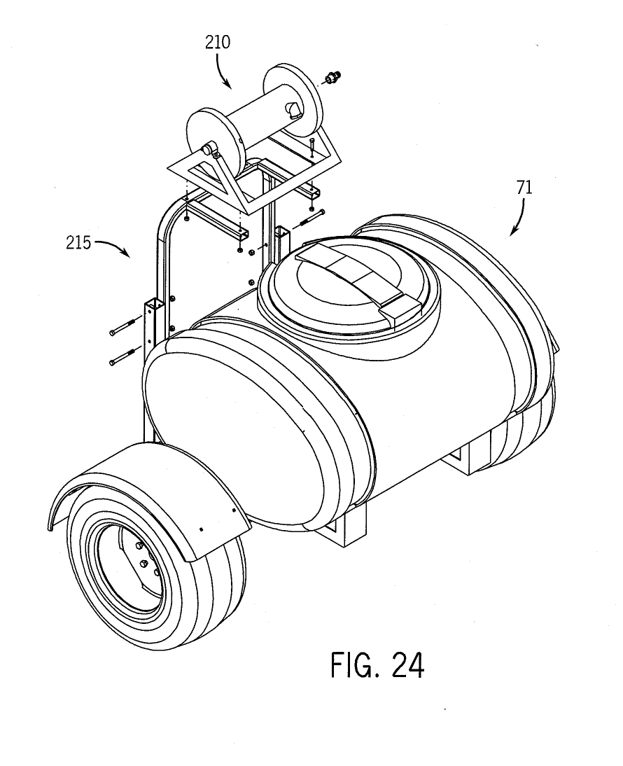

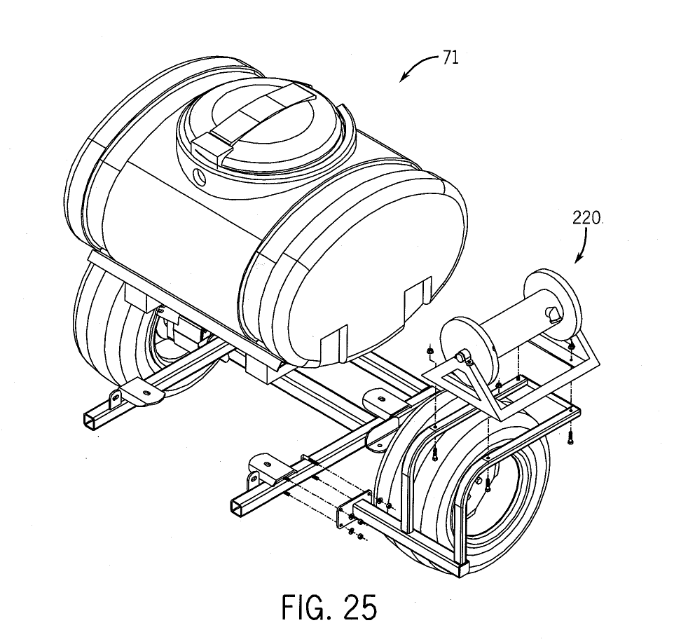

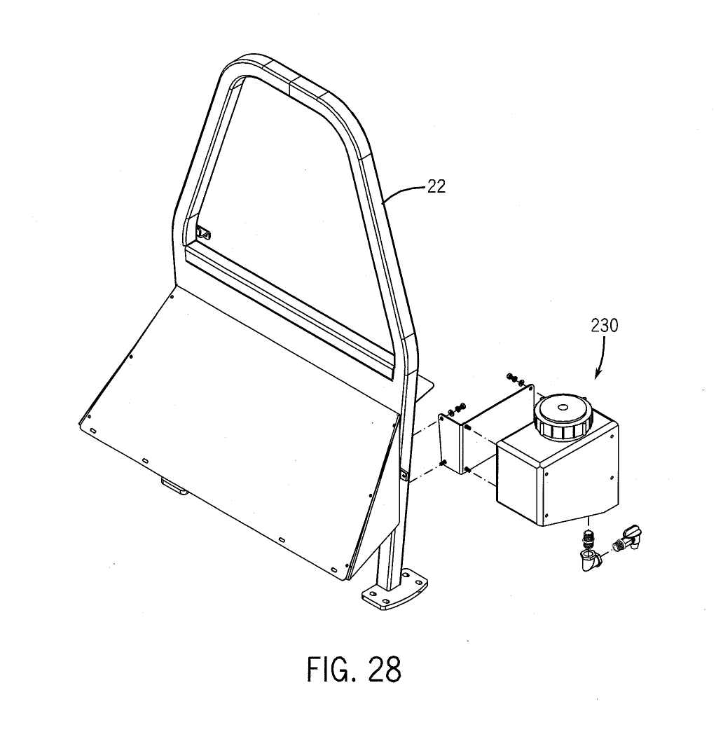

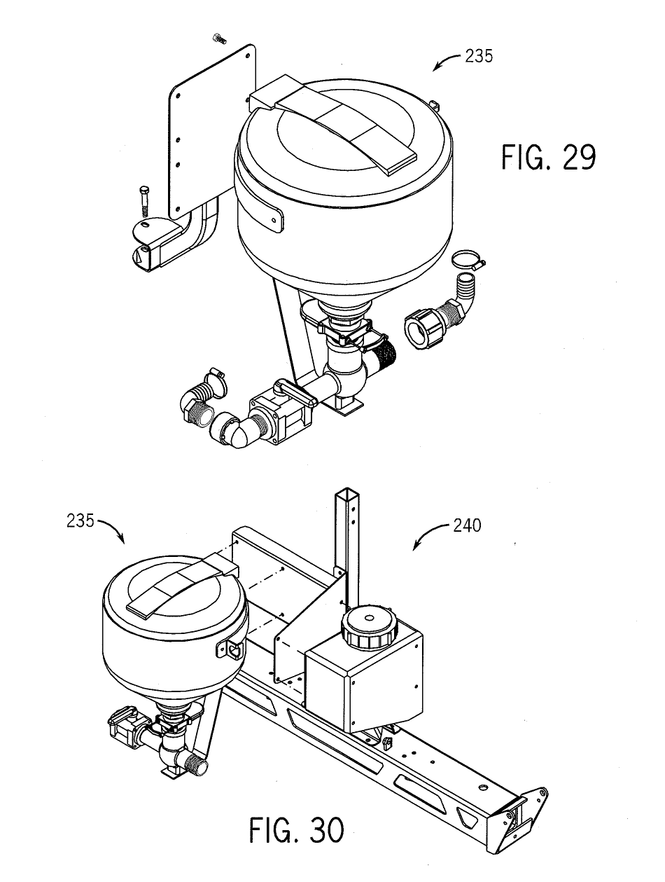

Optional equipment which may be used on the sprayer 10 includes a hose system including a manual hose reel. 210, an embodiment of which is shown in FIG. 23, a hose reel mount 215 shown in FIG. 24, a electric/manual hose reel and mount 220 shown in FIG. 25, a hose reel plumbing assembly 225 shown in FIG. 27, a fresh water wash tank assembly 230 shown in FIG. 28, a chemical clean load system 235 shown in FIG. 29, and mount 240 therefor shown in FIG. 30.

The benefits of the invention include low noise, low pollution, and minimal hydraulic oil spillage.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A sprayer comprising a vehicle, a sprayer connected to the vehicle, and an electric power system for moving the vehicle and for operating the sprayer.

2. The sprayer of claim 1, wherein the vehicle comprises a frame having at least two wheels.

3. The sprayer of claim 2, wherein the vehicle has a frame and a pair of axle assemblies connected to the frame, each axle assembly having a pair of wheels, one axle assembly having an electric motor for moving the wheels, one axle assembly having a brake for stopping the wheels, an operator seat connected to the frame, and operator controls connected to the frame, including a steering mechanism communicatively connected to at least one axle assembly and an actuator communicatively connected to the electric motor.

4. The sprayer of claim 1, wherein the sprayer includes a liquid material storage connected to the vehicle, and a spray assembly communicatively connected to the liquid material storage.

5. The sprayer of claim 4, wherein the liquid material storage includes at least one tank.

6. The sprayer of claim 4, wherein the spray assembly includes a pumping system communicatively connected to the electric power system and to the liquid material storage.

7. The sprayer of claim 6, wherein the pumping system includes an electric motor connected to the electric power system, a gearbox connected to the electric motor, and a pump connected to the gearbox, to the liquid material, and to a spray egress.

8. The sprayer of claim 4, wherein the spray assembly includes a filtering system communicatively connected to the liquid material storage.

9. The sprayer of claim 8, wherein the filtering system includes at least one valve communicatively connected to the liquid material storage for controlling throughput of liquid material, a strainer filter communicatively connected to the valve and to at least one spray egress, a gauge communicatively connected to the strainer filter for measuring pressure of liquid material in the sprayer, and a pressure relief valve communicatively connected to the strainer filter.

10. The sprayer of claim 4, wherein the spray assembly includes a distribution system communicatively connected to the liquid material storage for controlling and selectively moving liquid material in at least a pair of directions.

11. The sprayer of claim 10, wherein the distribution system includes a manifold having an inlet communicatively connected to the liquid material storage and a plurality of outlets communicatively connected to a plurality of separate spray egresses.

12. The sprayer of claim 11, wherein the distribution system further includes a control valve communicatively connected to the manifold.

13. The sprayer of claim 11, wherein the distribution system further includes a flow meter communicatively connected to the manifold.

14. The sprayer of claim 4, wherein the spray assembly includes: (a) a pumping system communicatively connected to the electric power system and to the liquid material storage; (b) a filtering system communicatively connected to the liquid material storage; and (c) a distribution system communicatively connected to the liquid material storage for controlling and selectively moving liquid material in at least a pair of directions.

15. The sprayer of claim 14, wherein the spray assembly further includes an electronic processor communicatively connected to the pumping system, the distribution system and the electric power system for controlling spraying.

16. The sprayer of claim 4, wherein the spray assembly is communicatively connected to a spray boom, the boom being communicatively connected to the vehicle and applying a spray to a predetermined location or area proximate the vehicle.

17. The sprayer of claim 1, wherein the electric power system includes at least one battery, at least one electric motor connected to the battery and to the vehicle for moving the vehicle, and at least one pump for supplying liquid material to the sprayer.

18. The sprayer of claim 17, wherein the electric power system further includes an electronic processor connected to the sprayer for controlling spraying.

19. A sprayer comprising
a. a vehicle;
b. a sprayer connected to the vehicle, wherein the sprayer includes a liquid material storage connected to the vehicle, a spray assembly communicatively connected to the liquid material storage, and a spray boom, the boom being communicatively connected to the vehicle and applying a spray to a predetermined location or area proximate the vehicle, and wherein the spray assembly includes: (a) a pumping system communicatively connected to the electric power system and to the liquid material storage; (b) a filtering system communicatively connected to the liquid material storage; and (c) a distribution system communicatively connected to the liquid material storage for controlling and selectively moving liquid material in at least a pair of directions in the spray boom; and
c. an electric power, system for moving the vehicle and for operating the sprayer.

20. A fully electric sprayer for use in golf course maintenance, comprising
a. a vehicle;
b. a sprayer connected to the vehicle, and including
(1) a liquid material storage connected to the vehicle,
(2) a spray assembly communicatively connected to the liquid material storage, the spray assembly including
(i) a pumping system communicatively connected to the electric power system and to the liquid material storage;
(ii) a filtering system communicatively connected to the liquid material storage; and
(ii) a distribution system communicatively connected to the liquid material storage for controlling and selectively moving liquid material in at least a pair of directions;
and
(3) a spray boom communicatively connected to the vehicle and to the distribution system for applying a spray to a predetermined location or area proximate the vehicle; and
c. an electric power system for moving the vehicle and for operating the sprayer, the electric power system including at least one battery, at least one electric motor connected to the battery, to the vehicle for moving the vehicle, and to at least one pump for supplying liquid material to the sprayer.
